(19) United States
(12) Patent Application Publication
(10) Pub. No.: US 2022/0250292 A1
(43) Pub. Date: Aug. 11, 2022

(54) Polybutylene Terephthalate With Low THF Content

(71) Applicant: LANXESS Deutschland GmbH, Cologne (DE)

(72) Inventors: Matthias Bienmueller, Krefeld (DE); Sebastian Harms, Cologne (DE)

(73) Assignee: LANXESS Deutschland GmbH, Cologne (DE)

(21) Appl. No.: 17/630,278

(22) PCT Filed: Jul. 27, 2020
(86) PCT No.: PCT/EP2020/071153

§ 371 Date: Jan. 26, 2022

(30) Foreign Application Priority Data
Jul. 29, 2019 (EP) 19188760.3

(51) Int. Cl. B29C 45/00; B29C 48/00; B29C 48/40; B29C 48/76

(52) U.S. Cl. CPC B29C 45/0001; B29C 48/022; B29K 2067/006; B29C 48/767; B29C 48/40

(57) ABSTRACT

The invention relates to injection molded parts, preferably injection molded parts in the form of automotive interior parts, having a low TVOC content and a low tetrahydrofuran content based on polybutylene terephthalate synthesized from butanediol and terephthalic acid, compounded in a compounder under vacuum and subsequently processed by injection molding, wherein TVOC stands for “Total Volatile Organic Compounds”.

The invention relates to injection molded parts, preferably injection molded parts in the form of automotive interior parts, having a low TVOC content and a low tetrahydrofuran content based on polybutylene terephthalate synthesized from butanediol and terephthalic acid, compounded in a compounder under vacuum and subsequently processed by injection molding, wherein TVOC stands for “Total Volatile Organic Compounds”.

Despite a certain complexity the past has seen no lack of attempts to find a means of assessing the multiplicity of volatile organic compounds, VOC for short, encountered in interiors. Use is made of a construct in the form of an indicator parameter where as an indicator for the VOC concentration in interiors the sum of the concentrations of the individual compounds is employed and used to determine the TVOC value (total volatile organic compounds); see: B. Seifert, Bundesgesundheitsblatt-Gesundheitsforschung-Gesundheitsschutz, 42, pages 270-278, Springer-Verlag 1999.

Unlike when determining an individual substance in indoor air, where the “measured object” is unambiguously defined, in this case the determination of n-decane, toluene or formaldehyde in particular, in the analysis of a VOC mixture it is necessary to consider which substances are to be described as VOCs. In order to achieve a uniform approach, a working group of the World Health Organization (WHO) which dealt with organic substances in indoor air carried out a classification of the organic compounds at an early stage. This WHO classification, which is based on boiling points, is shown in Tab. 1 and it must be noted that according to this definition neither formaldehyde nor diethylhexyl phthalate belong to the VOCs.

TABLE 1
Classification of organic compounds in indoor air according to WHO

| Group name* | Abbreviation | Boiling point range** [° C.] | Sampling technique |
|---|---|---|---|
| Very volatile organic compounds | VVOC | <0 to 50-100 | Gas collecting tube or canister; |
| | | | adsorption on activated carbon |
| Volatile organic compounds | VOC | 50-100 to 250-260 | Adsorption on Tenax, graphitized |
| | | | carbon or activated carbon |
| Semivolatile organic compounds | SVOC | 250-260 to 380-500 | Adsorption on polyurethane foam |
| | | | or XAD-2 |
| Organic compounds associated | POM | >380 | Sampling with filters |
| with particulate matter or | | | |
| particulate organic matter | | | |

*In order to better document the origin of the abbreviations also used in German texts, this column of Tab. 1 uses the English descriptions. The corresponding German terms are as follows: VVOC = Sehr/leicht flüchtige organische Verbindungen [very volatile organic compounds], VOC = Flüchtige organische Verbindungen (häufig als FOV abgekürzt) [volatile organic compounds (often abbreviated to FOV)], SVOC = Schwerflüchtige organische Verbindungen [semivolatile organic compounds], POM = Partikelgebundene organische Verbindungen [particulate organic matter];
**Polar compounds are at the upper end of the range;

According to G. Blinne, Kunststoffe 10/1999, polybutylene terephthalate (PBT) in the form of compounds, preferably reinforced with glass fibers, is an essential plastic in the electrical engineering/electronics sectors and the vehicle industry, especially the automotive industry. Thus AutomobilKONSTRUKTION 2/2011, pages 18-19 describes the use of PBT blends for delicate loudspeaker grilles and ventilation grilles in automotive interior parts. WO 2013/020627 A1 describes inter alia functionalized interior trim components for a motor vehicle based on PBT.

As a semicrystalline plastic, PBT has a narrow melting range in the range from 220° C. to 225° C. The high crystalline proportion makes it possible for stress-free molded parts made of PBT to be subjected to short-term heating to below the melting temperature without deformation and damage. Pure PBT melts exhibit short-term thermal stability up to 280° C. and do not undergo substantial molecular degradation nor exhibit substantial evolution of gases and vapors. However, like all thermoplastic polymers PBT does decompose under excessive thermal stress, in particular upon superheating or during cleaning by burn-off methods. This forms gaseous decomposition products. Decomposition accelerates above about 300° C. and initially mainly tetrahydrofuran (THF) and water are formed.

According to EP 2 029 271 A1, THF is already formed during production of PBT through intramolecular condensation from the monomer 1,4-butanediol (BDO) to be employed as a reactant. The reaction can be catalyzed both by the employed terephthalic acid (PTA) and by the titanium-based catalyst usually used to produce the PBT. It is alternatively possible to use dimethyl terephthalate (DMT) instead of PTA.

However, THF is also continuously regenerated in the PBT melt at high temperatures. This process, also referred to as “back-biting”, takes place at the BDO end groups of the polymer. Similarly to THF formation from BDO monomer, this back-biting is an intramolecular condensation which affords the undesired byproduct tetrahydrofuran. The THF regeneration in back-biting too is catalyzed by acid end groups of terephthalic acid and by residues of catalyst present, preferably titanium-based catalyst. The effects of tetrahydrofuran on human health and the environment have been tested by Germany in 2013 as part of a substance assessment under REACH. The IARC (International Agency for Research on Cancer) classified tetrahydrofuran as a possible carcinogen in 2017.

Apart from technical measures to avoid THF during the production of PBT, increasing health awareness and increasing consumer demands on the olfactory quality of motor vehicles mean that efforts are being made to reduce or even completely avoid any outgassing of materials installed in the automotive interior part, in particular under the influence of elevated temperatures as a result of solar radiation. To this end the Verband der Automobilhersteller (VDA) has issued two test specifications based on different gas chromatographic methods, VDA 277 and VDA 278, to quantify the outgassing from components installed in automotive vehicle interiors.

VDA 277, which is based on a static headspace method and flame ionization detection (FID) and indicates the total TVOC content of volatile carbon compounds, was published in 1995. This was followed in 2002 by VDA 278 which is based on a dynamic headspace method, so-called thermal desorption, and indicates both the volatile organic compounds (VOC) and the condensable components (fog value). The corresponding threshold values, which always apply to the components to be investigated after injection molding, are set by the individual automakers (OEMs) but are usually based on the suggestions of the VDA.

In view of the requirements of VDA 277, numerous attempts to reduce the THF emissions of PBT have hitherto been made:

EP 0 683 201 A1 Addition of a sulfonic acid component during the polymerization, though the sulfonic acid components themselves have now been classified as health-hazardous to carcinogenic;

EP 1 070 097 A1 (WO99/50345 A1) Addition of polyacrylic acid to polyesters based on lactic acid during polymerization to deactivate Sn or Sb catalysts used in PBT production;

EP 1 999 181 A2 (WO2007/111890A2) Addition of a phosphorus-containing component to deactivate the titanium catalyst used in PBT production. The values of the emissions specified in EP 1 999 181 A2 are percentages, i.e. they are not absolute values and are in any case in need of improvement;

EP 2 427 511 B1 Addition of a styrene-acrylic polymer (for example Joncryl®ADR-4368) in a concentration of 0.01% to 2%, but this resulted in chain extension and an increase in the molecular weight of the PBT;

EP 2 816 081 A1 Addition of a chelating agent from the group of sodium hypophosphite, nitrilotriacetic acid, disodium salt of EDTA, diammonium salt of EDTA, EDTA, diethylenetriaminepentaacetic acid, hydroxyethylenediamine triacetic acid, ethylenediamine disuccinic acid and, in particular, 1,3-propylenediamine tetraacetic acid;

EP 3 181 639 A1 discloses injection molded components based on polybutylene terephthalate which is synthesized by reacting butanediol with terephthalic acid or dimethyl terephthalate;

US 2012 235090 A1 teaches reducing the level of volatile compounds from polyester-based injection molded parts where, after reaction of butanediol with terephthalic acid or dimethyl terephthalate, the resulting polybutylene terephthalate is processed in a compounder in the form of a twin-screw extruder;

JP 2006 298993 A also describes a method for reducing the THF content of polybutylene terephthalate-based injection molded parts;

EP 3 004 242 A1 (WO2014/195176 A1) Addition of sodium hypophosphite or epoxy-functionalized styrene-acrylic acid polymer for production of PBT molded parts comprising not more than 100 μgC/g of TVOC according to VDA277.

Proceeding from this prior art it is an object of the present invention to provide PBT-based compounds for processing by injection molding for automotive interior parts having an optimized TVOC value and THF outgassing behavior, wherein the outgassing behavior measured on the injection molded part is to be understood as meaning a TVOC of <50 μgC/g according to VDA 277 and a VOC_{THF} of <5 μg/g according to VDA 278 as per the Verband der Automobilindustrie (VDA). This object shall preferably be achieved without the use of the additives recited in the above prior art.

It has surprisingly been found that just applying a vacuum of <200 mbar in the last third of the compounding sector of a twin-screw extruder after the filler incorporation zone and before spinoff of the melt strand in the discharging zone surprisingly reduced the measurable TVOC value for the injection-molded PBT-based component for automotive interiors according to VDA 277 from more than 90 μgC/g to less than 40 μgC/g and the measurable VOC_{THF} according to VDA 278 from 6 μg/g to only 4.5 μg/g, wherein all reported values relate to the condition defined in the relevant test specification as described hereinbelow.

Just applying a vacuum/a pressure of <200 mbar to a twin-screw extruder for obtaining PBT compounds, preferably in granulated form, is additionally sufficient to reduce the THF content to such an extent that even after processing of the PBT compound by injection molding, a sufficiently small amount of THF is regenerated to allow automotive interiors which meet the requirements of both VDA 277 and VDA 278 from the outset to be produced therefrom.

The present invention demonstrates that, in contrast to the prior art, no additization of PBT is required to meet the requirements of VDA 277 and VDA 278 in terms of THF for PBT-based automotive interior parts.

The invention therefore relates to injection molded parts, preferably injection molded parts in the form of automotive interior parts, based on polybutylene terephthalate which is synthesized by reaction of butanediol with terephthalic acid or dimethyl terephthalate,
compounded in a compounder in the form of a twin-screw extruder having a vacuum degassing zone at a pressure of <200 mbar at a throughput in the range from 1 to 10 t/h, preferably in the range from 3 to 8 t/h,
and subsequently processed by injection molding, preferably by supplying it to the injection molding apparatus in the form of pellets,
   with the proviso that the vacuum is applied in the last third of the compounding sector of the twin-screw extruder after the filler incorporation zone and before spinoff of the melt strand in the discharging zone and the twin-screw extruder comprises the processing zones feeding means, intake zone, melting zone, atmospheric degassing zone, at least one filler feeding zone, filler incorporation zone, backup zone, vacuum degassing zone, pressurizing zone and discharging zone and the last third of the compounding sector is based on the total length of the twin-screw extruder.

The invention relates to injection molded parts, preferably injection molded parts in the form of automotive interior parts, in particular having a TVOC to be determined according to VDA 277 of <50 μgC/g and a VOC_{THF} to be determined according to VDA 278 of <5 μg/g based on
polybutylene terephthalate which is synthesized by reacting butanediol with terephthalic acid or dimethyl terephthalate,
compounded in a compounder in the form of a twin-screw extruder having a vacuum degassing zone at a pressure of <200 mbar at a throughput in the range from 1 to 10 t/h, preferably in the range from 3 to 8 t/h,
and subsequently processed by injection molding, preferably by supplying it to the injection molding apparatus in the form of pellets,
   with the proviso that the vacuum is applied in the last third of the compounding sector of the twin-screw extruder after the filler incorporation zone and before spinoff of the melt strand in the discharging zone and the twin-screw extruder comprises the processing zones feeding means, intake zone, melting zone, atmospheric degassing zone, at least one filler feeding zone, filler incorporation zone, backup zone, vacuum degassing zone, pressurizing zone and discharging zone and the last third of the compounding sector is based on the total length of the twin-screw extruder.

The invention further relates to the use of at least one compounder in the form of a twin-screw extruder having a vacuum degassing zone at a pressure of <200 mbar with a throughput in the range from 1 to 10 t/h, preferably in the range from 3 to 8 t/h, for producing PBT-based compounds for processing into injection molded parts, preferably into injection molded parts in the form of automotive interior parts, having a TVOC to be determined according to VDA 277 of <50 μgC/g and a VOC_{THF} to be determined according to VDA 278 of <5 μg/g, and with the proviso that the vacuum is applied in the last third of the compounding sector of the twin-screw extruder after the filler incorporation zone and before spinoff of the melt strand in the discharging zone and the PBT is synthesized by reaction of butanediol with terephthalic acid or dimethyl terephthalate and the twin-screw extruder comprises the processing zones feeding means, intake zone, melting zone, atmospheric degassing zone, at least one filler feeding zone, filler incorporation zone, backup zone, vacuum degassing zone, pressurizing zone and discharging zone and the last third of the compounding sector is based on the total length of the twin-screw extruder.

The invention finally relates to a method for reducing the THF content in PBT-based injection molded parts, preferably injection molded parts in the form of automotive interior parts, where after reaction of butanediol with terephthalic acid or dimethyl terephthalate the resulting PBT is processed in a compounder in the form of a twin-screw extruder having a vacuum degassing zone at a pressure of <200 mbar with a throughput in the range from 1 to 10 t/h, preferably in the range from 3 to 8 t/h, processed into compounds and subsequently, preferably in the form of pellets, supplied to an injection molding apparatus, and with the proviso that the vacuum is applied in the last third of the compounding sector of the twin-screw extruder after the filler incorporation zone and before spinoff of the melt strand in the discharging zone and the twin-screw extruder comprises the processing zones feeding means, intake zone, melting zone, atmospheric degassing zone, at least one filler feeding zone, filler incorporation zone, backup zone, vacuum degassing zone, pressurizing zone and discharging zone and the last third of the compounding sector is based on the total length of the twin-screw extruder.

For the sake of clarity it is noted that the scope of the present invention comprises all of the definitions and parameters recited below in general or in preferred ranges in any desired combinations. In the context of the present invention all reported pressures are to be understood as absolute pressures. Unless otherwise stated the standards recited in the context of this application relate to the edition current on the application date of the present invention. The terms compounder and extruder are used synonymously in the context of the present invention.

In terms of VDA 277, the present invention refers to the 1995 version, while in terms of VDA 278, the present invention refers to the October 2011 version.

The testing of TVOC, TVOC_{THF} and of VOC_{THF} in the context of the present invention was carried out according to the specifications of the respective standard:

VDA 277 specifies that sampling must be carried out immediately after receipt of goods or in a condition corresponding thereto. Transport and handling of the freshly injection molded parts is to be carried out airtightly in aluminum-coated PE bags, generally without conditioning.

VDA 278 specifies that the material to be examined should normally be airtightly packaged in aluminum-coated PE bags within 8 hours of manufacture and that the sample should be sent to the laboratory immediately. Prior to measurement, the samples are to be conditioned for 7 days under standard climactic conditions (23° C., 50% relative humidity).

The TVOC_{THF} determined in the context of the present invention was determined by the same method as TVOC according to VDA277, wherein evaluation was based on the individual substance THF. In the context of the present invention, TVOC_{THF} is therefore indicative of the THF emissions behavior of a sample.

In the context of the present invention, VOC_{THF} is determined by the same method as VOC according to VDA278, wherein evaluation is based on the individual substance THF. VOC_{THF} is therefore indicative of the THF emission behavior of a sample.

Compounding (to compound =“to put together”) is a term from the plastics industry which describes the processing of plastics by admixing of additives, preferably of fillers, additives etc. to achieve desired profiles of properties. In the context of the present invention, compounding is carried out in a twin-screw extruder having a vacuum degassing zone, preferably in a corotating twin-screw extruder having a vacuum degassing zone. Compounding comprises the process operations of conveying, melting, dispersing, mixing, degassing and pressurization and spinoff of the melt strand and subsequent pelletization. The product of a compounding is a compound and is preferably marketed as pellets.

The purpose of compounding is to convert the plastic raw material, in the case of the present invention the PBT resulting from the reaction of butanediol with terephthalic acid, into a plastic molding compound having the best possible properties for processing and later use, here in the form of an automotive interior part according to VDA 277 and VDA 278. The objectives of compounding include changing the particle size, incorporating additives and removing constituents. Since many plastics are generated as powders or large particle size resins and are therefore unsuitable for processing machines, especially injection molding machines, the further processing of these raw materials is particularly important. The finished mixture of polymer, here PBT, and additives is called molding compound. Prior to processing, the individual components of the molding compounds may be in various states of matter such as pulverulent, granular or liquid/flowable. The objective of using a compounder is to mix the components as homogeneously as possible to afford the molding compound.

Compounding may also be used to remove constituents. It is preferable to remove two components, namely moisture fractions (dehumidification) or low-molecular weight components (degassing). In the context of the present invention, the THF obtained as a byproduct in the synthesis of the PBT is removed from the molding compound by applying a vacuum.

Two essential steps in compounding are mixing and pelletizing. In the context of mixing a distinction is made between distributive mixing, i.e. uniform distribution of all particles in the molding compound, and dispersive mixing, i.e. distribution and comminution of the components to be incorporated. The mixing process itself may be performed either in the viscous phase or in the solid phase. When mixing in the solid phase, the distributive effect is preferred since the additives are already in comminuted form. Since mixing in the solid phase is rarely sufficient to achieve a good mixing quality, it is often referred to as premixing. The premix is then mixed in the molten state. Viscous mixing generally comprises five operations: melting the polymer and the additives (as far as possible in the latter case), comminuting the solid agglomerates (agglomerates are conglomerations), wetting the additives with polymer melt, uniformly distributing the components and separating undesired constituents, preferably air, moisture, solvent and, in the case of the PBT to be considered according to the invention, THF. The heat required for viscous mixing is substantially caused by the shearing and friction of the components. In the case of the PBT to be considered according to the invention it is preferable to employ viscous mixing.

Since most processors require the plastic, in the present case the PBT-based compound, to be in the form of pellets, pelletization plays an ever more important role. A basic distinction is made between hot cutting and cold cutting. This results in different particle forms according to the processing. In the case of hot cutting, the plastic is preferably obtained in the form of pearls or lenticular pellets. In the case of cold cutting, the plastic is preferably obtained after compounding in cylindrical or cubic form.

In the case of hot cutting, the extruded strand is chopped immediately downstream of a die of the compounder by a rotating knife having a coolant flowing over it. The coolant prevents the individual pellets from sticking together and cools the material. Cooling is preferably effected using water but it is also possible to use air. Selection of the right coolant is therefore material dependent. The disadvantage of water cooling is that the pellets require subsequent drying. In the case of cold cutting, the strands are first drawn through a water bath and then cut to the desired length in the solid state by a rotating knife roller (granulator). In the case of the PBT to be employed according to the invention, cold cutting is preferably employed. In the case of the PBT to be employed according to the invention, the pellets obtained from the compounder are dried with warm air at elevated temperature.

According to Vakuum (de.wikipedia.org), other than standard pressure of 1013.25 mbar and an ideal vacuum of 0 mbar, those skilled in the art distinguish between subatmospheric pressure >300 mbar, coarse vacuum in the range from 1 to 300 mbar, fine vacuum in the range from 1 to 10⁻³ mbar, high vacuum in the range from 10⁻³ to 10⁻⁷ mbar, ultrahigh vacuum in the range from 10⁻⁷ to 10⁻¹² mbar and extremely high vacuum of <10⁻¹² mbar.

### PREFERRED EMBODIMENTS OF THE INVENTION

### Compounder

It is preferable according to the invention to perform the compounding of the PBT for automotive interior parts using a corotating twin-screw extruder having a vacuum degassing zone as the compounding extruder. The objectives of a compounder in the form of a twin-screw extruder having a vacuum degassing zone include intake of the plastic composition supplied thereto, compression thereof, simultaneous plasticization and homogenization by supplying energy, and supply to a profiling mold under pressure. Twin-screw extruders having a vacuum degassing zone and having a corotating pair of screws preferably employable according to the invention are suitable for compounding PBT, preferably for incorporating at least one filler into the PBT.

Twin-screw extruders having a vacuum degassing zone to be employed according to the invention are known to those skilled in the art for example from DE 203 20 505 U1 and are preferably marketed by Coperion Werner & Pfleiderer GmbH & Co.KG, Stuttgart. A twin-screw extruder having a vacuum degassing zone to be employed according to the invention is divided into a plurality of processing zones. These zones are interlinked and cannot be considered independently of one another. DE 203 20 505 U1, the content of which is hereby fully incorporated into the present invention by reference, divides the processing zones of a twin-screw extruder preferably employable according to the invention, also referred to as a compounding sector in the context of the present invention, into the feeding means (14), intake zone (15), melting zone (16), atmospheric degassing zone (17), at least one filler feeding zone (18), filler incorporation zone (19), backup zone (20), vacuum degassing zone (21), pressurizing zone (22) and discharging zone (23). According to the invention, the vacuum is applied in the last third of the compounding sector after the (last) filler incorporation zone and before spinoff of the melt strand in the discharging zone.

According to the invention, the twin-screw extruder having a vacuum degassing zone is operated at a throughput in the range from 1 to 10 t/h (tons per hour), preferably at a throughput in the range from 3 to 8 t/h.

It is preferable according to the invention to employ a twin-screw extruder having a vacuum degassing zone and having a screw diameter in the range from 30 mm to 120 mm, preferably in the range from 60 to 100 mm.

According to the invention, a pressure of <200 mbar is applied to the vacuum degassing zone of the twin screw extruder, preferably a pressure of <150 mbar, particularly preferably a pressure in the range from 0.1 to 130 mbar. In the context of the present invention reported pressures are subatmospheric pressures/vacuums and are based on the respective prevailing atmospheric pressure (relative pressure). According to DIN 28400-1, a vacuum is defined as “the state of a gas when the pressure of the gas and thus the particle number density is lower in a container than outside, or when the pressure of the gas is lower than 300 mbar, i.e. less than the lowest atmospheric pressure on the earth's surface”. The vacuums sought in accordance with the invention are preferably achieved using vacuum pumps from the range of rotary vane pumps, liquid ring pumps, scroll pumps, Roots pumps and screw pumps. See: 1.1.1 Vakuum-Definition (pfeiffer-vacuum.com/de/know-how/einfuehrung-in-die-vakuumtechnik/allgemeines/vakuum-definition/).

According to the invention, the vacuum degassing zone is located in the last third of the compounding sector, wherein the last third is to be understood relative to the total length of the twin-screw extruder. The total length of the twin-screw extruder is defined as the distance between the start of the intake zone and the end of the discharging zone. The last third expressly includes the discharging zone.

The result of the compounding of PBT in the twin-screw extruder having a vacuum degassing zone in the last third of the compounding sector after the filler incorporation zone and before spinoff of the melt strand in the discharging zone at a pressure of <200 mbar is a THF-reduced compound in pellet form having a very low THF content. This THF content is so low that even after processing of the granulate in injection molding, wherein decomposition processes result in THF regeneration, it is still possible to produce products, especially automotive interior parts, having a TVOC to be determined according to VDA 277 of <50 μgC/g and a VOC_{THF} to be determined according to VDA 278 of <5 μg/g.

### Polybutylene Terephthalate

PBT employable according to the invention [CAS No. 24968-12-5] is available for example from Lanxess Deutschland GmbH, Cologne under the trade name Pocan®.

The viscosity number of the PBT to be employed according to the invention to be determined in a 0.5% by weight solution in a phenol/o-dichlorobenzene mixture in a 1:1 weight ratio at 25° C. according to DIN EN ISO 1628-5 is preferably in a range from 50 to 220 cm³/g, particularly preferably in the range from 80 to 160 cm³/g; see: Schott Instruments GmbH brochure, O. Hofbeck, 2007-07.

Especial preference is given to PBT whose carboxyl end group content to be determined by titration methods, in particular potentiometry, is up to 100 meq/kg, preferably up to 50 meq/kg and in particular up to 40 meq/kg polyester. Such polyesters are producible for example by the method of DE-A 44 01 055. The content of carboxyl end groups (CEG) in the PBT to be employed according to the invention was in the context of the present invention determined by potentiometric titration of the acetic acid liberated when a sample of the PBT dissolved in nitrobenzene was reacted with a defined excess of potassium acetate.

Polyalkylene terephthalates are preferably produced with Ti catalysts. After polymerization, a PBT to be employed according to the invention preferably has a Ti content to be determined by X-ray fluorescence analysis (XRF) according to DIN 51418 of ≤250 ppm, particularly preferably <200 ppm, especially preferably <150 ppm. Such polyesters are preferably produced according to the method in DE 101 55 419 B4, the content of which is hereby fully incorporated by reference.

### Fillers

In a preferred embodiment, at least one filler is incorporated into the PBT via at least one filler feeding zone in the compounding sector of the twin-screw extruder. In this case, compounds according to the invention preferably contain 0.001 to 70 parts by mass, particularly preferably 5 to 50 parts by mass, very particularly preferably 9 to 48 parts by mass, of at least one filler, in each case based on 100 parts by mass of PBT.

In one embodiment, the present invention relates to compounds and injection molded components producible therefrom without filler.

Compounding preferably employs the fillers: antioxidants, lubricants, impact modifiers, antistats, fibers, talc, barium sulfate, chalk, heat stabilizers, iron powder, light stabilizers, release agents, demolding agents, nucleating agents, UV absorbers, flame retardants, polytetrafluoroethylene, glass fibers, carbon black, glass spheres, silicone.

Fillers preferably employable for PBT according to the invention are selected from the group consisting of talc, mica, silicate, quartz, titanium dioxide, wollastonite, kaolin, kyanite, amorphous silicas, magnesium carbonate, chalk, feldspar, barium sulfate, glass spheres and fibrous fillers, in particular glass fibers or carbon fibers. It is especially preferable to employ glass fibers.

According to Faser-Kunststoff-Verbund (de.wikipedia.org), a distinction is made between chopped fibers, also known as short fibers, having a length in the range from 0.1 to 1 mm, long fibers having a length in the range from 1 to 50 mm and continuous fibers having a length L>50 mm. Short fibers are used in injection molding and are directly processable with an extruder. Long fibers can likewise still be processed in extruders. Said fibers are widely used in fiber spraying. Long fibers are frequently added to thermosets as a filler. Continuous fibers are used in the form of rovings or fabric in fiber-reinforced plastics. Products comprising continuous fibers achieve the highest stiffness and strength values. Also available are ground glass fibers, the length of these after grinding typically being in the range from 70 to 200 μm.

It is preferable according to the invention to employ as filler chopped long glass fibers having a starting length in the range from 1 to 50 mm, particularly preferably in the range from 1 to 10 mm, very particularly preferably in the range from 2 to 7 mm. Initial length refers to the average length of the glass fibers as present prior to compounding of the compounds according to the invention to afford a molding compound according to the invention. The fibers, preferably glass fibers, employable as filler may as a consequence of compounding in the product in the form of an automotive interior part have a d90 and/or d50 value smaller than the originally employed fibers or glass fibers. Thus, the arithmetic average of the fiber length/glass fiber length after processing is frequently only in the range from 150 pm to 300 μm, as determinable by laser diffractometry according to ISO 13320.

In the context of the present invention, the fiber length and fiber length distribution/glass fiber length and glass fiber length distribution are in the case of processed fibers/glass fibers determined according to ISO 22314, which provides for intially ashing the samples at 625° C. Subsequently, the ash is placed onto a microscope slide covered with demineralized water in a suitable crystallizing dish and the ash is distributed in an ultrasound bath without action of mechanical forces. The next step comprises drying in an oven at 130° C. followed by determination of glass fiber length with the aid of optical microscopy images. For this purpose, at least 100 glass fibers are measured from three images, and so a total of 300 glass fibers are used to ascertain the length. The glass fiber length can be calculated either as the arithmetic average lₙ according to the equation

$${l}_{n} = \frac{1}{n} \cdot {\sum }_{i}^{n} {l}_{i}$$

where lᵢ=length of the ith fiber and n=number of measured fibers and advantageously shown as a histogram or for an assumed normal distribution of the measured glass fiber lengths l may be determined using the Gaussian function according to the equation

$$f ( l ) = \frac{1}{\sqrt{2 π} \cdot σ} \cdot {e}^{- \frac{1}{2} {( \frac{l - {l}_{c}}{σ} )}^{2}}$$

In this equation, l_{c} and σ are specific parameters of the normal distribution: l_{c} is the mean and σ is the standard deviation (see: M. Schoßig, Schädigungsmechanismen in faserverstärkten Kunststoffen, 1, 2011, Vieweg and Teubner Verlag, page 35, ISBN 978-3-8348-1483-8). Glass fibers not incorporated into a polymer matrix are analyzed with respect to their lengths by the above methods, but without processing by ashing and separation from the ash.

The glass fibers [CAS No. 65997-17-3] preferably employable as filler according to the invention preferably have a fiber diameter in the range from 7 to 18 μm, particularly preferably in the range from 9 to 15 μm, determinable by X-ray computed microtomography analogously to J. KASTNER, et al. DGZfP [German Society for Non-Destructive Testing] annual meeting 2007-talk 47. The glass fibers preferably employable as filler are preferably added in the form of chopped or ground glass fibers.

In a preferred embodiment, the fillers, preferably glass fibers, are modified with a suitable size system or an adhesion promoter/adhesion promoter system. Preference is given to using a silane-based size system or adhesion promoter. Particularly preferred silane-based adhesion promoters for the treatment of the glass fibers preferably employable as filler are silane compounds of general formula (I)

(X—(CH₂)_{q})ₓ—Si—(O—CrH₂ᵣ₊₁)₄₋ₖ (I)

wherein

X is NH₂—, carboxyl-, HO— or

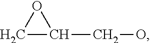

q is an integer from 2 to 10, preferably 3 to 4,

r is an integer from 1 to 5, preferably 1 to 2, and

k is an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane and the corresponding silanes comprising as the substituent X a glycidyl group or a carboxyl group, wherein carboxyl groups are especially particularly preferred.

For the modification of the glass fibers preferably employable as filler, the adhesion promoter, preferably the silane compounds of formula (I), is employed preferably in amounts of 0.05% to 2% by weight, particularly preferably in amounts of 0.25% to 1.5% by weight and very particularly preferably in amounts of 0.5% to 1% by weight, in each case based on 100% by weight of the filler.

As a consequence of the processing to afford the compound/to afford the product or component the glass fibers preferably employable as filler may be shorter in the compound/in the product than the originally employed glass fibers. Thus, the arithmetic average of the glass fiber length after processing, to be determined by high-resolution x-ray computed tomography, is frequently only in the range from 150 μm to 300 μm.

According to Glasfasern (r-g.de/wiki), glass fibers are produced in the melt spinning process (die drawing, rod drawing and die blowing processes). In the die drawing process, the hot mass of glass flows under gravity through hundreds of die bores of a platinum spinneret plate. The filaments can be drawn at a speed of 3-4 km/minute with unlimited length.

Those skilled in the art distinguish between different types of glass fibers, some of which are listed here by way of example:
E glass, the most commonly used material having an optimal cost-benefit ratio (E glass from R&G)
H glass, hollow glass fibers for reduced weight (R&G hollow glass fiber fabric 160 g/m² and 216 g/m²)
R, S glass, for elevated mechanical requirements (S2 glass from R&G)
D glass, borosilicate glass for elevated electrical requirements
C glass, having increased chemicals resistance
Quartz glass, having high thermal stability

Further examples may be found at Glasfaser (de.wikipedia.org). E glass fibers have gained the greatest importance for plastics reinforcing. E stands for electrical glass, since it was originally used in the electrical industry in particular.

For the production of E glass, glass melts are produced from pure quartz with additions of limestone, kaolin and boric acid. As well as silicon dioxide, they contain different amounts of various metal oxides. The composition determines the properties of the products. Preferably employed according to the invention is at least one type of glass fibers from the group of E glass, H glass, R, S glass, D glass, C glass and quartz glass, particular preferably glass fibers made of E glass.

Glass fibers made from E glass are the most widely used filler. The strength properties correspond to those of metals (for example aluminum alloys), the specific weight of laminates containing E glass fibers being lower than that of the metals. E glass fibers are nonflammable, heat resistant up to about 400° C. and stable to most chemicals and weathering effects.

Also particularly preferably employed as filler are platelet-shaped mineral fillers. A platelet-shaped mineral filler is according to the invention to be understood as meaning at least one mineral filler having a pronounced platelet-shaped character from the group of kaolin, mica, talc, chlorite and intergrowths such as chlorite talc and plastorite (mica/chlorite/quartz). Talc is particularly preferred.

The platelet-shaped mineral filler preferably has a length:diameter ratio for determination by high-resolution x-ray computed tomography in the range from 2:1 to 35:1, more preferably in the range from 3:1 to 19:1, especially preferably in the range from 4:1 to 12:1. The average particle size of the platelet-shaped mineral fillers for determination by high-resolution x-ray computed tomography is preferably less than 20 μm, particularly preferably less than 15 ∞m, especially preferably less than 10 μm.

Also preferably employed as filler however is non-fibrous and non-foamed milled glass having a particle size distribution to be determined by laser diffractometry according to ISO 13320 having a d90 value in the range from 5 to 250 μm, preferably in the range from 10 to 150 μm, particularly preferably in the range from 15 to 80 μm, very particularly preferably in the range from 16 to 25 μm. In connection with the d90 values, their determination and their significance, reference is made to Chemie Ingenieur Technik (72) pages 273-276, 3/2000, Wiley-VCH Verlags GmbH, Weinheim, 2000, according to which the d90 value is that particle size below which 90% of the amount of particles lie (median value).

It is preferable according to the invention when the non-fibrous and non-foamed milled glass has a particulate, non-cylindrical shape and has a length to thickness ratio to be determined by laser diffractometry according to ISO 13320 of less than 5, preferably less than 3, particularly preferably less than 2. It will be appreciated that the value of zero is impossible.

The non-foamed and non-fibrous milled glass particularly preferably employable as filler is additionally characterized in that it does not have the glass geometry typical of fibrous glass with a cylindrical or oval cross section having a length to diameter ratio (L/D ratio) to be determined by laser diffractometry according to ISO 13320 greater than 5.

The non-foamed and non-fibrous milled glass particularly preferably employable as filler according to the invention is preferably obtained by milling glass with a mill, preferably a ball mill and particularly preferably with subsequent sifting or sieving. Preferred starting materials for the milling of the non-fibrous and non-foamed milled glass for use as filler in one embodiment also include glass wastes such as are generated as unwanted byproduct and/or as off-spec primary product (so-called offspec goods) in particular in the production of glass articles of manufacture. This includes in particular waste glass, recycled glass and broken glass such as may be generated in particular in the production of window or bottle glass and in the production of glass-containing fillers, in particular in the form of so-called melt cakes. The glass may be coloured, but preference is given to non-coloured glass as the starting material for use as filler.

Particularly preferred according to the invention are long glass fibers based on E glass (DIN 1259), preferably having an average length d50 of 4.5 mm, such as are obtainable for example from LANXESS Deutschland GmbH, Cologne, as CS 7967.

### Other Additives

Further additives may also be compounded into the PBT. Additives preferably incorporable according to the invention in addition to the at least one filler are stabilizers, in particular UV stabilizers, heat stabilizers, gamma ray stabilizers, also antistats, elastomer modifiers, flow promoters, demolding agents, flame retardants, emulsifiers, nucleating agents, plasticizers, lubricants, dyes, pigments and additives for increasing electrical conductivity. These and further suitable additives are described, for example, in Gachter, Müller, Kunststoff-Additive, 3rd Edition, Hanser-Verlag, Munich, Vienna, 1989 and in Plastics Additives Handbook, 5th Edition, Hanser-Verlag, Munich, 2001. The additives may be employed alone or in admixture/in the form of masterbatches.

### Injection Molded Components

Injection molded components according to the invention are preferably employed as automotive interior parts. In the context of the present invention, the term automotive interior parts relates to all injection molded parts that are not constituents of the outer surface of a motor vehicle or that do not have any proportion of their area on the outer surface of a motor vehicle.

Injection molded parts for an automotive interior part to be produced according to the invention include not only the components described in the prior art above but also preferably trim pieces, plugs, electrical components or electronic components. These are installed in increasing numbers in the interior of modern automobiles to enable the increasing electrification of many components, in particular vehicle seats or infotainment modules. PBT-based components are also often used in automobiles for functional parts that are subject to mechanical stress.

### Method of Production for Injection Molded Components of an Automotive Interior

The processing of PBT-based compounds to be employed according to the invention is carried out in four steps:
1) polymerization of the PBT from BDO and PTA or BDO and DMT;
2) compounding of the PBT, preferably with at least one filler, in particular talc or glass fibers, and optionally at least one further additive, in particular heat stabilizer, demolding agent or pigment, where the additives are added to the melt of PBT in a twin-screw extruder having a vacuum degassing zone at a throughput in the range from 2 to 10 t/h under vacuum at a pressure of <200 mbar, incorporated thereinto and commixed therein with the proviso that the vacuum is applied in the last third of the compounding sector of the twin-screw extruder after the filler incorporation zone and before spinoff of the melt strand in the discharging zone;
3) discharging and solidifying of the melt and pelletization and drying of the pellets, preferably with warm air, at elevated temperature;
4) production of an injection molded component/an injection molded component in the form of an automotive interior part from the dried pellets by injection molding.

### Injection Molding

Processes according to the invention for producing automotive interior parts by injection molding are preferably performed at melt temperatures in the range from 160° C. to 330° C., particularly preferably in the range from 190° C. to 300° C. In addition it is preferable when pressures of not more than 2500 bar, preferably of not more than 2000 bar, very particularly preferably of not more than 1500 bar and especially preferably of not more than 750 bar, are employed during injection molding. The PBT-based compounds according to the invention feature exceptional melt stability, wherein in the context of the present invention melt stability will be understood by those skilled in the art to mean that even after residence times >5 min at markedly above the melting point of the molding material of >260° C., no increase in the melt viscosity determinable according to ISO 1133 (1997) is observed.

The method of injection molding comprises melting (plasticizing) the raw material, preferably in pellet form, in a heated cylindrical cavity, and injection thereof as an injection molding material under pressure into a temperature-controlled cavity of a profiling mold. Employed as raw material are compounds according to the invention which have been processed into a molding compound by compounding and where said molding compound has in turn preferably been processed into pellets. However, in one embodiment pelletizing may be eschewed and the molding compound directly supplied under pressure to a profiling mold. After cooling (solidification) of the molding compound injected into the temperature-controlled cavity, the injection-molded part is demolded and optionally freed of adhering sprues.

In the method according to the invention, the polybutylene terephthalate is preferably sent for injection molding in the form of pellets.

The method according to the invention preferably employs a corotating twin-screw extruder. The method according to the invention preferably employs a twin-screw extruder having a screw diameter in the range from 30 mm to 120 mm. In the method according to the invention, it is preferable to apply a vacuum at a pressure in the range <200 mbar, particularly preferably at a pressure in the range from 50 to 150 mbar, very particularly preferably at a pressure in the range from 0.1 to 130 mbar.

The method according to the invention preferably employs a polybutylene terephthalate having a viscosity number to be determined in a 0.5% by weight solution in a phenol/o-dichlorobenzene mixture in a weight ratio of 1:1 at 25° C. according to DIN EN ISO 1628-5 in a range from 50 to 220 cm³/g. In the method according to the invention it is preferable to employ a polybutylene terephthalate produced with Ti catalysts. The method according to the invention preferably employs polybutylene terephthalate which after polymerization has a Ti content to be determined by X-ray fluorescence analysis according to DIN 51418 of ≤250 ppm.

The method according to the invention preferably employs polybutylene terephthalate into which at least one filler is incorporated, preferably in amounts of 0.001 to 70 parts by mass based on 100 parts by mass of polybutylene terephthalate. The method according to the invention preferably employs long glass fibers as filler.

The method according to the invention preferably produces injection molded components for motor vehicle interior parts. These are preferably trim pieces, plugs, electrical components or electronic components.

For the sake of clarity it is noted that the scope of the method according to the invention comprises all of the definitions and parameters recited in connection with the injection molded parts in general or in preferred ranges in any desired combinations. The examples which follow serve to elucidate the invention but have no limiting effect.

### Examples

### TVOC

In order to determine the TVOC value of samples in the context of the present invention, about 2 g in each case of a comminuted sample were according to the specification of VDA 277 (pieces of about 20 mg) weighed into a 20 mL sample vial having a screw cap and septum. These were heated in a headspace oven for 5 hours at 120° C. A small sample of the gas space was then injected into the gas chromatograph (Agilent 7890B GC) and analyzed. An Agilent 5977B MSD detector was used. The analysis was performed in triplicate and evaluated by means of acetone calibration. The result was determined in μgC/g. The threshold value not to be exceeded in the context of the present invention was 50 μgC/g. The analysis was based on the VDA 277 test specification.

### VOC

The VOC value was determined when according to the specification of VDA 278 20 mg of a sample was weighed into a thermal desorption tube for a GERSTEL-TD 3.5 instrument with a frit from Gerstel (020801-005-00). Said sample was heated to 90° C. for 30 minutes in a helium stream and the thus-desorbed substances were frozen out at −150° C. in a downstream cold trap. Once the desorption time had elapsed the cold trap was quickly heated to 280° C. and the collected substances were separated by chromatography (Agilent 7890B GC). Detection was effected using an Agilent 5977B MSD. Evaluation for THF was effected by means of toluene calibration. The result was determined in μg/g. The threshold value not to be exceeded in the context of the present invention was 5 μg/g of THF. The analysis was based on the VDA 278 test specification.

### Reactants

Polybutylene terephthalate (PBT): LANXESS Pocan® B1300

Glass fiber (GF): LANXESS CS7967D

### Example 1 (Inventive)

The employed compounder was a corotating ZSK 92 MC18 twin-screw extruder from Coperion having a screw diameter of 92 mm. The twin screw extruder was operated at a melt temperature of 270+/−5° C. and a throughput of 4 tons per hour. A vacuum of 100 mbar was applied in the vacuum degassing zone of the twin-screw extruder in the last third of the compounding sector after the last mixing zone and before spinoff of the melt strand. The compound discharged as a strand after the discharging zone of the twin-screw extruder was cooled in a water bath, dried on a ramp in an air stream and then subjected to dry pelletization.

The example employed a PBT molding material containing 43.3 parts by mass of chopped glass fibers per 100 parts by mass of PBT. The PBT Pocan® B1300 employed for this compounding operation had a TVOC value determined according to VDA 277 of 170 μgC/g.

The compounded material in the form of pellets was then dried for 4 h at 120° C. in a dry air dryer and processed by injection molding under standard conditions at 260° C. melt temperature and 80° C. mold temperature into multipurpose test specimens 1A according to DIN EN ISO 527-2.

### Comparative Example

The employed compounder was a corotating ZSK 92 MC18 twin-screw extruder from Coperion having a screw diameter of 92 mm. The twin-screw extruder was operated at a melt temperature of 270+/−5° C. and a throughput of 4 tons per hour. A vacuum of 300 mbar was applied in the vacuum degassing zone of the twin-screw extruder in the last third of the compounding sector after the last mixing zone and before spinoff of the melt strand. The compound discharged as a strand after the discharging zone of the twin-screw extruder was cooled in a water bath, dried on a ramp in an air stream and then subjected to dry pelletization.

The comparative example likewise employed a PBT molding material containing 43.3 parts by mass of chopped glass fibers per 100 parts by mass of PBT. The PBT Pocan® B1300 employed for this compounding operation had a TVOC value determined according to VDA 277 of 170 μgC/g.

The compounded material in the form of pellets was then likewise dried for 4 h at 120° C. in a dry air dryer and processed by injection molding under standard conditions at 260° C. melt temperature and 80° C. mold temperature into multipurpose test specimens 1 A according to DIN

EN ISO 527-2.

TABLE 2

| | VDA 277: | | VDA 278: |
|---|---|---|---|
| Parts by mass based on 100 parts by | TVOC | TVOC_{THF} | VOC_{THF} |
| mass of PBT | [μgC/g] | [μgC/g] | [μg/g] |
| Comparative example: | | | |
| 43.3 parts by mass of GF | 60.3 | 54.7 | 4.9 |
| Pellets | | | |
| Component (injection molded) | 95.2 | 82.5 | 6.0 |
| Example 1 (inventive) | | | |
| 43.3 parts by mass of GF | 29.3 | 26.9 | 2.1 |
| Pellets | | | |
| Component (injection molded) | 35.8 | 32.5 | 4.5 |

In the example according to the invention both in the inventive example and in the comparative example, 5 multipurpose test specimens 1A according to DIN EN ISO 527-2 were produced and the THF content thereof determined according to VDA 277 and VDA 278 [component (injection molded)]. Tab. 2 reports the averaged values from respective sets of two measurements (duplicate determination). In the case of the investigated pellets 2×2 g (VDA277) or 2×20 mg (VDA278) were weighed and the THF content thereof determined in duplicate determination according to VDA 277 and VDA 278.

Tab. 2 shows the TVOC and TVOC_{THF} values determined according to the specification of VDA 277 on the dried pellets prior to injection molding and on the injection molded multipurpose test specimen 1A according to DIN EN ISO 527-2. Also shown are the THF values measured according to VDA 278 on the dried granulate before use in injection molding and on the injection molded multi-purpose test specimen 1A according to DIN EN ISO 527-2.

The test results reported in Tab. 2 show that the compounding conditions optimized with a vacuum of 100 mbar results in markedly lower THF emission values determined according to VDA277 and VDA278 not only for the compounded pellets but also for the injection-molded part produced therefrom.

Improving the degassing vacuum in the vacuum degassing zone of the employed twin-screw extruder from 300 mbar to 100 mbar resulted in a marked reduction in the total (TVOC) and THF emission (TVOC_{THF}, VOC_{THF}) in the measurement on the injection molded part.

This result is greatly surprising to those skilled in the art and the size of the effect is completely unexpected since the low polymer melt surface area and the short residence time in the vacuum degassing zone of the twin-screw extruder would have been expected to provide at best a very small effect given the very high throughput of 4 t/h and a screw diameter of 92 mm. Also completely surprising to the person skilled in the art is that the increase in the TVOC value in the injection molding process compared to the pellets after compounding is markedly lower for the inventive example at 22% (from 29.3 μgC/g to 35.8 μgC/g) than for the comparative example at 58% (from 60.3 μgC/g to 95.2 μgC/g).

1. An injection molded component based on polybutylene terephthalate which is synthesized by reacting butanediol with terephthalic acid or dimethyl terephthalate,
compounded in a compounder in the form of a twin-screw extruder having a vacuum degassing zone at a pressure of <200 mbar at a throughput in the range from 1 to 10 t/h,
and subsequently processed by injection molding, and
with the proviso that the vacuum is applied in the last third of the compounding sector of the twin-screw extruder after the filler incorporation zone and before spinoff of the melt strand in the discharging zone and the twin-screw extruder comprises the processing zones feeding means, intake zone, melting zone, atmospheric degassing zone, at least one filler feeding zone, filler incorporation zone, backup zone, vacuum degassing zone, pressurizing zone and discharging zone and the last third of the compounding sector is based on the total length of the twin-screw extruder.

2. The injection molded component as claimed in claim 1, wherein said component is an automotive interior part.

3. The injection molded component as claimed in claim 1, wherein the polybutylene terephthalate is sent for injection molding in the form of pellets.

4. The injection molded component as claimed in claim 1, wherein a corotating twin-screw extruder is used.

5. The injection molded component as claimed in claim 1, wherein a twin-screw extruder having a screw diameter in the range from 30 mm to 120 mm is employed.

6. The injection molded component as claimed in claim 1, wherein a vacuum at a pressure in the range of <150 mbar is applied.

7. The injection molded component as claimed in claim 1, wherein a polybutylene terephthalate having a viscosity number to be determined in a 0.5% by weight solution in a phenol/o-dichlorobenzene mixture in a weight ratio of 1:1 at 25° C. according to DIN EN ISO 1628-5 in a range from 50 to 220 cm³/g is employed.

8. The injection molded component as claimed in claim 1, wherein the polybutylene terephthalate is produced with Ti catalysts.

9. The injection molded component as claimed in claim 8, wherein after polymerization the polybutylene terephthalate has a Ti content to be determined by X-ray fluorescence analysis according to DIN 51418 of ≤250 ppm.

10. The injection molded component as claimed in claim 1, wherein at least one filler is incorporated into the polybutylene terephthalate.

11. The injection molded component as claimed in claim 10, wherein long glass fibers are employed as filler.

12. The injection molded component as claimed in claim 1, wherein said component is an automotive interior part.

13. The injection molded component as claimed in claim 12, wherein the automotive interior part is selected from trim pieces, plugs, electrical components or electronic components.

14. A method of preparing polybutylene terephthalate-based compounds for processing into injection molded parts having a TVOC to be determined according to VDA 277 of <50 μgC/g and a VOC_{THF} to be determined according to VDA 278 of <5 μg/g, comprising processing polybutylene terephthalate in at least one compounder in the form of a twin-screw extruder having a vacuum degassing zone at a pressure of <200 mbar with a throughput in the range from 1 to 10 t/h, with the proviso that the vacuum is applied in the last third of the compounding sector of the twin-screw extruder after the filler incorporation zone and before spinoff of the melt strand in the discharging zone and the polybutylene terephthalate is synthesized by reaction of butanediol with terephthalic acid or dimethyl terephthalate and the twin-screw extruder comprises the processing zones feeding means, intake zone, melting zone, atmospheric degassing zone, at least one filler feeding zone, filler incorporation zone, backup zone, vacuum degassing zone, pressurizing zone and discharging zone and the last third of the compounding sector is based on the total length of the twin-screw extruder.

15. A method for reducing the THF content in polybutylene terephthalate-based injection molded parts, comprising processing polybutylene terephthalate, synthesized by reaction of butanediol with terephthalic acid or dimethyl terephthalate, in a compounder in the form of a twin-screw extruder having a vacuum degassing zone under vacuum at a pressure of <200 mbar with a throughput in the range from 1 to 10 t/h, and supplying the resulting polybutylene terephthalate-based compounds to an injection molding apparatus, with the proviso that the vacuum is applied in the last third of the compounding sector of the twin-screw extruder after the filler incorporation zone and before spinoff of the melt strand in the discharging zone and the twin-screw extruder comprises the processing zones feeding means, intake zone, melting zone, atmospheric degassing zone, at least one filler feeding zone, filler incorporation zone, backup zone, vacuum degassing zone, pressurizing zone and discharging zone and the last third of the compounding sector is based on the total length of the twin-screw extruder.

16. The injection molded component as claimed in claim 6, wherein the pressure applied to the vacuum degassing zone is in the range from 50 to 150 mbar.

17. The injection molded component as claimed in claim 6, wherein the pressure applied to the vacuum degassing zone is in the range from 0.1 to 130 mbar.

18. The method as claimed in claim 15, wherein the throughput is in the range from 3 to 8 t/h.

19. The method as claimed in claim 14, further comprising pelletizing the polybutylene terephthalate-based compounds.

20. The method as claimed in claim 15, wherein the polybutylene terephthalate-based compounds are supplied to the injection molding apparatus in the form of pellets.
